(19) United States
(12) Patent Application Publication
(10) Pub. No.: US 2006/0003172 A1
(43) Pub. Date: Jan. 5, 2006

(54) Composite element and method for producing the same

(75) Inventors: Anton Scherer, Rehau (DE); Uwe Schuster, Koditz (DE); Matthias Thumler, Hof (DE); Holm Riepenhausen, Rehau (DE); Markus Grundmann, Bad Berneck (DE)

Correspondence Address: VENABLE LLP, P.O. BOX 34385, WASHINGTON, DC, 20045-9998, US

(73) Assignee: Rehau AG & Co., Rehau (DE)

(21) Appl. No.: 11/171,246

(22) Filed: Jul. 1, 2005

(30) Foreign Application Priority Data
Jul. 3, 2004 (DE) 102004032362.3

(51) Int. Cl. B32B 15/04

(52) U.S. Cl. 428/457

(57) ABSTRACT

A composite element is made by inserting a reinforcing component into a first injection-molding section of an injection-molding tool, injection-molding a plastic support component onto the reinforcing component to form an intermediate product, moving the intermediate product to a second injection-molding section of the injection-molding tool, and injection-molding a plastic top component onto the intermediate product.

### CROSS-REFERENCE TO RELATED APPLICATION

The present application claims priority from German Patent Application DE 102004032362.3 filed on Jul. 3, 2004, the entire contents of which are incorporated herein by reference.

### BACKGROUND OF THE INVENTION

The present invention relates to a composite element and a method for producing such a composite element that is useful for supporting, lining, protecting, decorating, and sealing a housing, particularly for the frame or bodywork of a vehicle. More particularly, the invention relates to a composite part that includes a support component of plastic, a top component of plastic and a reinforcing component of metal disposed between the support component and the top component, and a method of making such a component.

A composite element and method for producing same are known, for example, from European Patent document EP 0335208 B1 and German Patent document DE 3415379 A1. These documents disclose a joint extrusion of a support component and a steel reinforcement to form an intermediate product. Then, a top component is sprayed onto the intermediate product. The disclosed production method is complicated and expensive. In addition, the total component tolerances for the composite element produced with this method are often excessively high, and undesirable surface defects can occur.

Therefore, there remains a need in the art for a method for producing a composite element that is cost-effective and produces products of high quality.

### SUMMARY OF THE INVENTION

The above and other objects are accomplished according to the invention by the provision of a method for producing a composite element, comprising: inserting a reinforcing component into a first injection-molding section of an injection-molding tool; injection-molding a plastic support component on to the reinforcing component to form an intermediate product; moving the intermediate product to a second injection-molding section of the injection-molding tool; and injection-molding a plastic top component on to the intermediate product to form the composite element having a reinforcing component disposed between the plastic support component and the plastic top component.

Thus, the present invention provides a method for making the composite element in which the plastic support component and the plastic top component are produced with an injection-molding technique. The reinforcing component is inserted into the injection-molding tool and the two plastic components surrounding the reinforcing component are produced by a multi-component injection-molding process. The two plastic components are therefore combined with the reinforcing component by using the same type of process, namely the injection molding process.

The method of the present invention may further include the step of producing the reinforcing component with a deep-drawing technique prior to inserting the metal reinforcing component into the first injection-molding section.

Further, the injection-molding tool may comprise a center portion disposed between a first edge portion and a second edge portion, with the center portion being movable relative to the first and second edge portions. The first injection-molding section is defined between the center portion and the first edge portion, and the second injection-molding section is defined between the center portion and the second edge portion. The center portion is rotatable with respect to the first edge portion and the second edge portion.

According to another aspect of the invention, a second reinforcing component may be inserted into the first injection-molding section substantially while the intermediate product is moved into the second injection-molding section. The plastic top component is injection-molded onto the intermediate product in the second injection-molding section substantially while a second plastic support component is injection-molded onto the second reinforcing component in the first injection-molding section to form a second intermediate product.

According to another embodiment of the invention, the injection molding tool may have a first mold half and a second mold half rotatable relative to the first mold half, with the first injection molding section and the second injection-molding section defined between the first mold half and the second mold half.

According to another feature of the invention, the reinforcing component may be metal, such as steel or aluminum, or a fiber composite material. As a result, composite elements with good surface structure can be produced. Fastening elements can be formed directly onto the support component during the multi-component injection-molding process, which additionally reduces the production expenditure and furthermore makes it possible to produce a low weight composite element. The injection-molding section may be defined to have cavities such that fastening elements are formed integrally onto the support component during injection-molding.

In the present invention, the injection-molding tools in particular can be arranged such that at least the main portion of the necessary displacement movement is realized with a tool part that is not provided with a sprue gate. In particular, the arrangement allows a continuous production. The continuous process saves time, because several required processing steps can run simultaneously. The reinforcing component can be mass produced with low production tolerances.

According to another aspect of the invention, there is provided a composite element that includes a plastic support component, a plastic top component, and a reinforcing component disposed between the plastic support component and the plastic top component. The support component and the top component are injection molded onto the reinforcing component as individual components in separate mold sections.

According to one feature of this aspect of the invention, the support component has a first shore hardness and the top component has a second shore hardness that is less than the first shore hardness. Further, the reinforcing component may made of metal, such as steel or aluminum, or may be a fiber composite material. The composite element may further have a bonding layer located on at least one side of the reinforcing component or fastening elements formed integrally on the support component. The fastening elements may be clips. The clips may be made of polyoxymethylene. The fastening elements may be substantially C-shaped. The reinforcing component may be substantially planar, and at least some sections of the reinforcing component may be positioned between the fastening elements and the top component. The fastening elements may be completely covered by the top component and sections of the reinforcing component.

The composite element of the present invention can be adapted to different requirements to be met by the support component as well as the top component. The reinforcing component as disclosed results in a composite element with advantageously low coefficients of elongation. The reinforcing component can also consist of aluminum or a fiber composite material.

The fastening elements are formed-on integrally, thereby resulting in a low-weight composite element. In many cases, additional connecting elements can be dispensed with. With a composite element as defined, the fastening elements can be attached to the support component in such a way that the contours are not visible on the top. Fastening elements as well as other types of geometric elements can be formed on at all locations where the reinforcing component covers the support component, without the contours being visible on the surface of the top component.

### BRIEF DESCRIPTION OF THE DRAWINGS

The features and advantages of the present invention will be further understood from the detailed description with reference to the following drawings:

FIGS. 1 to 3 are cross-sectional views of different embodiments of the composite element of the present invention with a plastic support component, a plastic top component, and a metal reinforcing component disposed between them.

FIGS. 4 to 7 are schematic illustrations of a process for producing the composite element by means of an injection-molding tool with three tool parts which can be moved relative to each other.

FIGS. 8 to 12 are schematic illustrations of an alternative process for producing the composite element with the aid of an injection-molding tool provided with two tool parts which can be moved relative to each other.

### DETAILED DESCRIPTION OF THE EMBODIMENTS

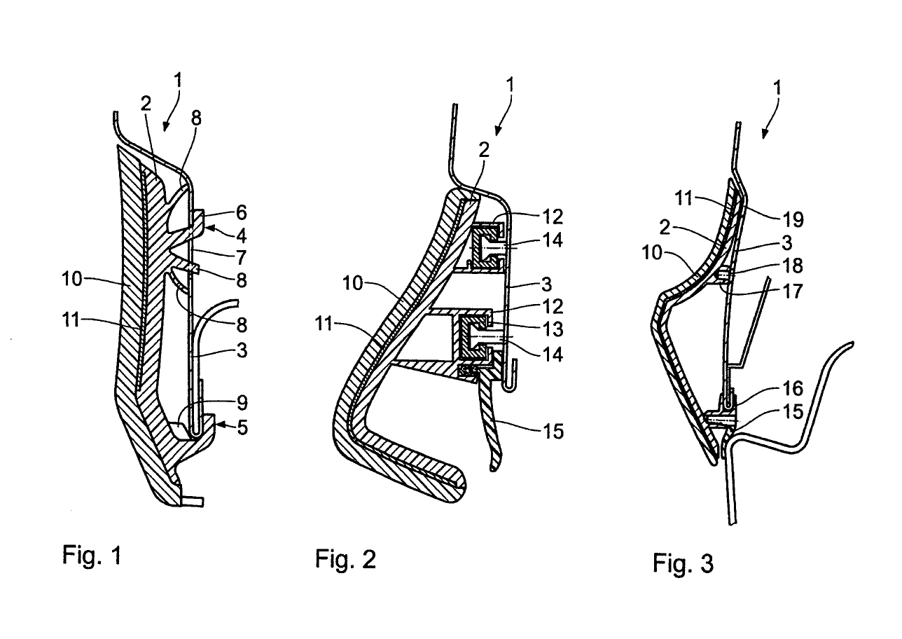

FIGS. 1 to 3 show variants of a composite element 1, using the example of a protective strip for placement around the lower edge of a passenger vehicle door. Identical parts of the different embodiments shown in FIGS. 1 to 3 are provided with the same reference numbers and will not be explained again.

In the following, the composite element 1 shown in FIG. 1 is described first. The composite element 1 comprises a support component 2 of plastic. The support component 2 is snapped onto the lower section of a door/chassis element 3. For this, the support component 2 is provided with numerous pairs of holding elements 4, 5, wherein one pair is shown in FIG. 1. The holding elements 4, 5 are formed integrally onto the support component 2.

The holding element 4 in each holding element pair is provided with a hook 6 which extends through and engages behind an opening 7 in the door/chassis element 3. The hook-shaped holding element 4 is furthermore provided with a total of three spacing webs 8, formed one above the other onto the support component 2, which ensure a defined positioning of the support component 2 relative to the door/chassis element 3.

The center spacing web 8 in this case ensures that the hook 6 remains in its position. The other two spacing webs 8 function as spacers between the support component 2 and the door/chassis element 3.

In addition to the hook-shaped holding element 4, each pair of holding elements also comprises a holding element 5, wherein the latter partially encircles the lower section of the door/chassis element 3. This lower section is positioned by means of support ribs 9 on the support component 2, in the region along the door/chassis element 3 which does not contain a snap-on holding element 5.

On the vehicle outside, the composite element 1 is covered with a top component 10 which also consists of plastic. Depending on the use, the plastic material used can be the same or a different type of plastic material as for the support component 2. The top component 10 is shaped in such a way that its surface is flush with the visible outside of the vehicle chassis.

A reinforcing component 11 made of metal, for example steel or aluminum, is disposed between the support component 2 and the top component 10 and functions to reinforce the composite element. The reinforcing component may also be made of a fiber composite material. The reinforcing component 11 furthermore predetermines the elongation of the composite element, so that differences in the coefficients of elongation for the support component 2 and/or the top component 10 are not important. The reinforcing component 11 covers the hook-shaped holding elements 4, thereby preventing undesirable contours of the hook-shaped holding elements 4 from being visible on the outside, through the top component 10.

The composite element 1 shown in FIG. 2 will now be described. The support component 2 is provided with integrally formed-on holding clips 12 as holding elements. Respectively two holding clips 12, arranged one above the other, form a holding-element pair which corresponds to the holding element pair described in connection with FIG. 1. The holding clips 12 are open toward the door/chassis element 3. Inserted into these holding clips 12 are clip elements 13 of polyoxymethylene (POM) with a C-shaped cross section, wherein these clip elements 13 are oriented such that the C-shape also opens toward the door/chassis element 3, as shown in the cross section. The heads of T-bolts 14 which are welded to the door/chassis element 3 engage in these clip elements 13. A receiving section of a sealing lip 15 is arranged between the support component 2 and the door/chassis element 3, below the lower holding clip 12.

When the door is closed, the sealing lip fits against a chassis part that is rigidly mounted to the frame and is not shown. The reinforcing component 11 shown in FIG. 2 is a preformed metal foil with a thickness in the range of approximately 0.5 mm.

The composite element shown in FIG. 3 will now be described. For this embodiment, a holding element pair comprises one embracing holding element 16 which is formed integrally onto the support component 2 and embraces the lower edge of the door/chassis element 3. The holding element pair furthermore includes a clip element 17 that is integrally formed onto the support component 2. The latter holds a clip bolt 18 which in turn is secured to the door/chassis element 3. For the embodiment shown in FIG. 3, an adhesive tape 19 is arranged in the upper end region of the composite element 1, between the support component 2 and the door/chassis element 3. This adhesive tape is designed in particular to keep the composite element 1 from rubbing against the door/chassis element 3. The reinforcing component 11 for the embodiment according to FIG. 3 is a metal foil having a thickness of approximately 0.4 mm.

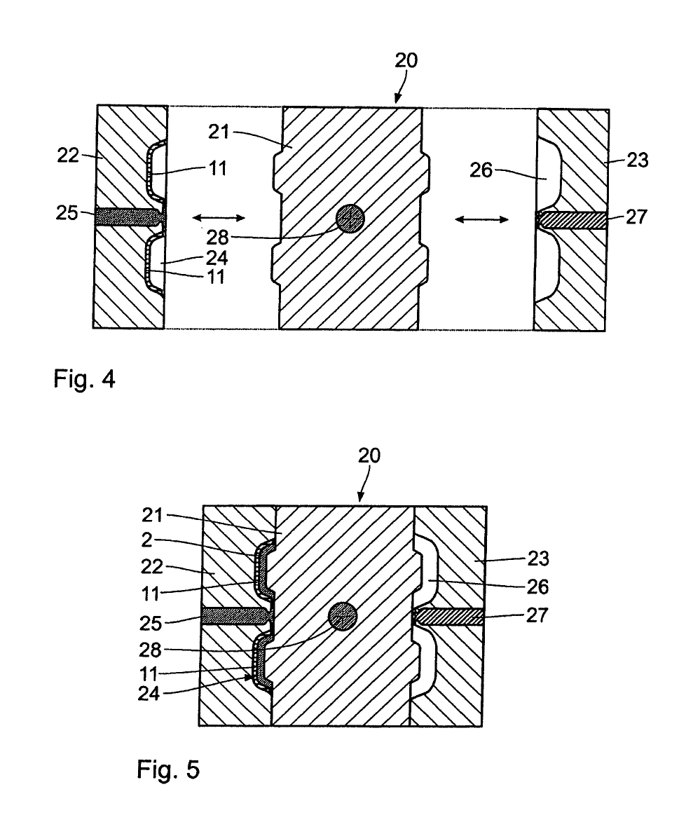

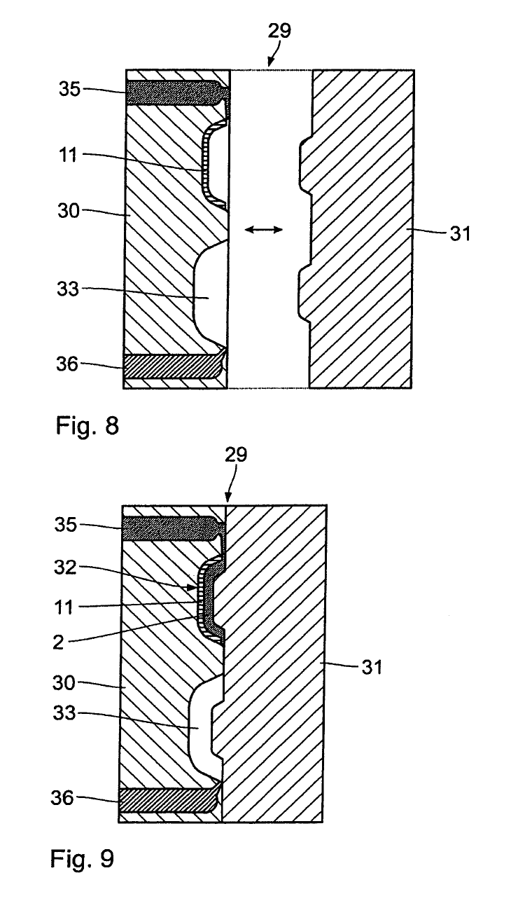

A first method for producing a composite element 1, shown in FIGS. 1 to 3, is illustrated schematically in FIGS. 4 to 7. The method is realized by means of an injection-molding tool 20, comprising three tool parts that can be moved relative to each other, wherein a center part 21 is positioned between two edge parts 22, 23. The edge parts 22, 23 can be displaced relative to the center part 21, along two double arrows shown in FIG. 4. When the injection-molding tool 20 is closed (as shown in FIGS. 5 and 7), two first injection-molding sections 24 are defined between the center part 21 and the first edge part 22, shown on the left in FIGS. 4 to 7. The injection-molding sections are used for shaping a first injection-molded component of the composite element 1, namely the support component 2. A first sprue gate 25 extends through the left edge part 22 up to the first two injection-molding sections 24. If the injection mold 20 is closed, two second injection-molding sections 26 are defined between the center part 21 and the second edge part 23, shown on the right side in FIGS. 4 to 7. These sections are used for shaping a second injection-molded component of the composite element 1, namely the top component 10. A second sprue gate 27 extends up to the two second injection-molding sections 26, wherein this gate extends through the right edge part 23. The center part 21 can be rotated around a central axis of rotation 28, positioned perpendicular to the drawing plane for FIGS. 4 to 7.

Using the three-part injection molding tool 20, the composite element 1 is produced as follows: The injection-molding tool 20 is initially in the opened position, as shown in FIG. 4. Two reinforcing components 11, produced in a preliminary step by means of deep-drawing, are inserted into the two first injection-molding sections 24. The reinforcing components 11 are provided on both sides with a bonding layer. Bonding layers of this type are known to the person skilled in the art.

The two reinforcing components 11 and the first injection-molding sections 24 in the region of the left edge part 22 have complementary shapes, so that the inserted reinforcing components 11 fit flush against the left edge part 22 of the injection-molding tool 20. Following this, the injection-molding tool 20 is closed, resulting in the closed position shown in FIG. 5. A first plasticized plastic material is then injected through the sprue gate 25 into the two first injection-molding sections 24 (e.g., upon the initial run of the injection-molding tool 20). During the initial filling of the injection-molding sections 24, a filling of the second injection-molding sections 26, between the center part 21 and the right edge part 23, can be omitted. Alternatively, the second injection-molding sections 26 can be filled on the initial run, and the resulting molded part discarded. The material filling injected into the first injection-molding sections 24 initially has a temperature that is high enough to cause a response of the bonding agent in the bonding layer of the reinforcing component 11, which is facing the plasticized plastic material. The hardening plastic material thus securely bonds with the reinforcing component 11.

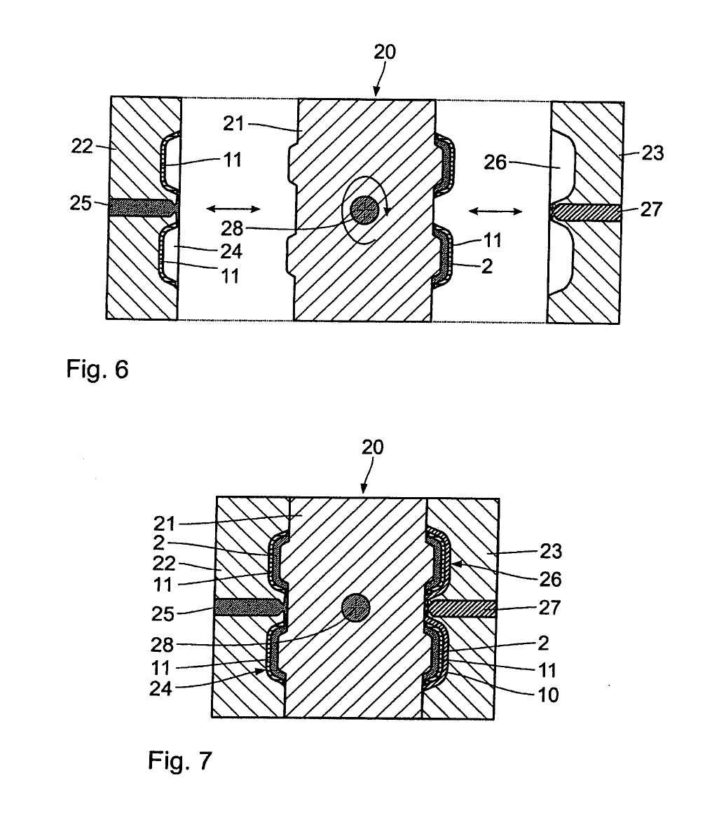

Since the bond between the plastic material and the center part 21 is stronger than the bond between the reinforcing component 11 and the edge part 22, the produced composite element consisting of the reinforcing component 11 and the first injection-molding component (eventually becoming the support component 2) adheres to the center part 21. In the following, this composite product is also referred to as an intermediate part or an intermediate product. The injection-molding tool 20 is subsequently moved back to the open position. The center part 21 is then rotated by 180° around the axis of rotation 28. FIG. 6 shows the position of the injection-molding tool 20 following completion of this rotation. In this opened position, an additional pair of reinforcing components 11 is inserted into the injection-molding sections 24 in the left edge part 22. The injection-molding tool 20 is then closed again. Following this, plasticized plastic material is injected through the two sprue gates 25, 27 into the injection-molding sections 24 and 26.

The first injection-molding component is again formed in the first injection-molding sections 24, as described in connection with FIG. 5. The respectively second injection-molding component, meaning the top component 10, is created in the second injection-molding sections 26 which are designed with more depth along the edges than the first injection-molding sections 24 (compare with FIG. 7). In the process, the hot plasticized material which is initially filled in bonds with the reinforcing component 11 via the bonding layer. The injection-molding tool 20 is then again moved to the opened position and the composite element produced in the second injection-molding sections 26 is ejected with the aid of an injector which is not shown herein. Following this, the processing steps previously described in connection with FIGS. 6 and 7 are repeated. During each injection-molding step, respectively one intermediate product that consists of the reinforcing component 11 and the support component 2 and one finished composite element 1, consisting of the reinforcing component 11, the support component 2, and the top component 10, is produced. The complete operation, comprising the steps of opening the injection-molding tool 20, inserting the reinforcing components 11, rotating the center part by 180°, closing the injection-molding tool 20, injecting the material, and ejecting the finished composite element 1 is then repeated, preferably with timed cycles.

An alternative method for producing a composite element 1 as shown in FIGS. 1 to 3 with an alternative two-part injection-molding tool 29 is described in FIGS. 8-12. Any details corresponding to those previously described in the above, in connection with the method and reference to FIGS. 4 to 7, will not be explained again in detail.

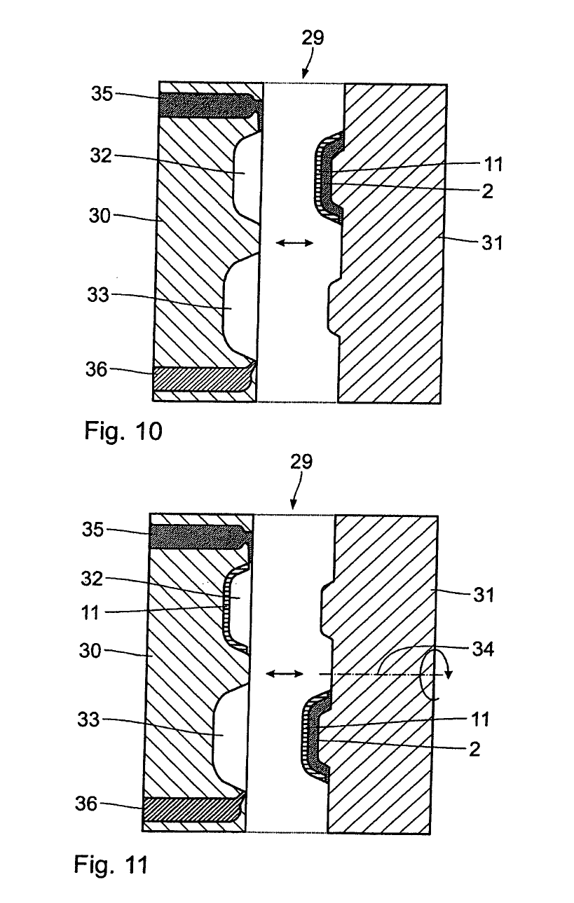

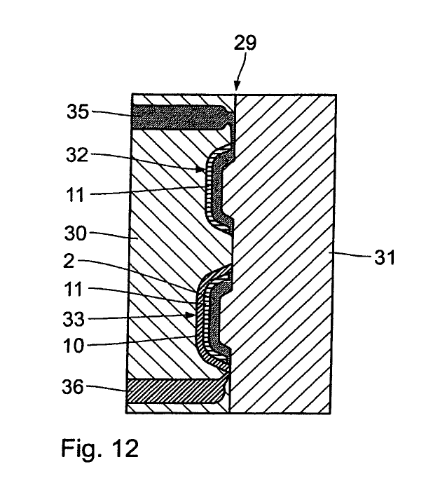

The injection-molding tool 29 comprises two tool parts 30, 31 which can be displaced in the direction of a double arrow shown in FIG. 8 for an opened position as shown in FIGS. 8, 10 and 11 and a closed position as shown in FIGS. 9 and 12. In the closed position, two injection-molding sections 32, 33 are defined between the two tool parts 30, 31. In addition to being displaceable along the double arrow shown in FIG. 8, the right tool part 31 can be rotated around an axis of rotation 34 (shown in FIG. 11) in the opened position of the injection-molding tool 29, where this axis of rotation is positioned horizontal in the drawing and in the drawing plane.

The left tool part 30 contains two sprue gates 35, 36. The sprue gate 35 which is shown at the top of the drawing is connected to the first injection-molding section 32 while the lower second sprue gate 36 in the drawing is connected to the second injection-molding section 33.

The production of composite elements 1 by means of the injection-molding tool 29 is described in the following. A reinforcing component 11 is initially inserted into the upper injection-molding section 32 while the injection-molding tool 29 is in the opened position. This situation is shown in FIG. 8. The injection-molding tool 29 is then closed and the first injection-molding step takes place. As explained in the above in connection with the process illustrated in FIGS. 4 to 7, an injection of material into the second injection-molding section 33 can be omitted during the initial injection operation (compare with FIG. 9). If this injection step is not omitted, then the very first component produced in the lower injection-molding section 33 can be discarded.

Following the injection, the intermediate part is created in the upper injection-molding section 32, as previously explained in connection with FIGS. 4 to 7. The injection-molding tool 29 is subsequently returned to the opened condition, a shown in FIG. 10. During the opening of the injection-molding tool 29, the intermediate part adheres to the right tool part 31, wherein this tool part is subsequently rotated by 180° around the axis of rotation 34, so that the injection-molding tool 29 is oriented as shown in FIG. 11. In FIG. 11, a new reinforcing component 11 is then inserted into the injection-molding section 32. Following this, the injection-molding tool 29 is closed once more. The material-injection step is then repeated, where the intermediate product is produced in the upper injection-molding section 32 and the composite element 1 is created in the lower injection-molding section 33 (compare with FIG. 1) via injection-molding. Following the opening of the injection-molding tool 29, the finished composite element is ejected. The production cycle is then repeated as described in the above in connection with FIGS. 10 to 12, preferably in timed cycles.

The injection-molding sections 24, 26, 32, 33 in particular can also be designed such that holding elements of the type as described in connection with the composite element 1 according to FIGS. 1-3 are formed integrally onto the support component 2. The injection-molding sections 24, 26, 32, 33 are also called mold cavities. For a different embodiment which is not shown herein, a larger number of injection-molding sections 24, 26, 32, 33 can also be provided for each injection-molding tool 20, 29.

It is particularly desirable if the reinforcing component 11 of a finished composite element 1 is enclosed on all sides by the plastic components 2, 10 to protect against corrosion. However, an enclosure of this type is not absolutely necessary. The reinforcing component 11 can already be inserted into the first injection-molding sections 24, 32 while the tool part 21 and/or 31 is still rotating around the axis 28 and/or 34.

It may be preferred that the support component 2 is made from a plastic material for which the shore hardness is higher than the shore hardness of the plastic material used to produce the top component 10.

The reinforcing component 11 for the embodiment described herein is made of steel. However, the reinforcing component 11 can also consist of aluminum or a fiber composite material.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

We claim:

1. A method for producing a composite element, comprising:
inserting a reinforcing component into a first injection-molding section of an injection-molding tool;
injection-molding a plastic support component onto the reinforcing component to form an intermediate product;
moving the intermediate product to a second injection-molding section of the injection-molding tool; and
injection-molding a plastic top component onto the intermediate product to form the composite element having a reinforcing component disposed between the plastic support component and the plastic top component.

2. The method according to claim 1, further comprising the step of producing the reinforcing component with a deep-drawing technique prior to inserting the metal reinforcing component into the first injection-molding section.

3. The method according to claim 1, wherein the injection-molding tool comprises a center portion disposed between a first edge portion and a second edge portion, with the center portion being movable relative to the first and second edge portions, wherein the first injection-molding section is defined between the center portion and the first edge portion, and the second injection-molding section is defined between the center portion and the second edge portion.

4. The method according to claim 3, wherein the center portion is rotatable with respect to the first edge portion and the second edge portion.

5. The method according to claim 1, wherein a second reinforcing component is inserted into the first injection-molding section substantially while the intermediate product is moved into the second injection-molding section.

6. The method according to claim 5, wherein the plastic top component is injection-molded onto the intermediate product in the second injection-molding section substantially while a second plastic support component is injection-molded onto the second reinforcing component in the first injection-molding section to form a second intermediate product.

7. The method according to claim 6, further comprising the step of ejecting the composite element from the second injection-molding section.

8. The method according to claim 1, wherein the injection molding tool comprises a first mold half and a second mold half rotatable relative to the first half, with the first injection molding section and the second injection-molding section being defined between the first mold half and the second mold half.

9. The method according to claim 1, wherein the reinforcing component is metal or a fiber composite material.

10. A composite element comprising:
a plastic support component,
a plastic top component,
a reinforcing component disposed between the plastic support component and the plastic top component,
wherein the support component and the top component are injection molded onto the reinforcing component as individual components in separate mold sections.

11. The composite element according to claim 10, wherein the support component has a first shore hardness and the top component has a second shore hardness that is less than the first shore hardness.

12. The composite element according to claim 10, wherein the metal reinforcing component is made of steel or aluminum.

13. The composite element according to claim 10, wherein the reinforcing component is a fiber composite material.

14. The composite element according to claim 10, further comprising a bonding layer located on at least one side of the reinforcing component.

15. The composite element according to claim 10, further comprising fastening elements formed integrally on the support component.

16. The composite element according to claim 15, wherein the fastening elements are clips.

17. The composite element according to claim 16, wherein the clips are made of polyoxymethylene.

18. The composite element according to claim 15, wherein the fastening elements are substantially C-shaped.

19. The composite element according to claim 15, wherein the reinforcing component substantially is planar, and at least some sections of the reinforcing component are positioned between the fastening elements and the top component.

20. The composite element according to claim 19, wherein the fastening elements are completely covered by the top component and sections of the reinforcing component.
